(19) United States
(12) Patent Application Publication
(10) Pub. No.: US 2025/0122673 A1
(43) Pub. Date: Apr. 17, 2025

(54) METHOD AND MOULD SYSTEM

(71) Applicant: Pulpex Limited, Sawston (GB)

(72) Inventors: Daniel George PROZESKY, Sawston (GB); Jason John WHITE, Southampton (GB)

(21) Appl. No.: 18/991,177

(22) Filed: Dec. 20, 2024

Related U.S. Application Data
(63) Continuation of application No. PCT/GB2023/051694, filed on Jun. 29, 2023.

(30) Foreign Application Priority Data
Jun. 30, 2022 (GB) 2209678.8

(51) Int. Cl. D21J 3/10

(52) U.S. Cl. CPC D21J 3/10

(57) ABSTRACT

A method of moulding a receptacle is described. The method comprises providing a mould, providing a partially formed receptacle within the mould, providing an expandable member (in a first configuration) within the partially formed receptacle, moving the expandable member (in the first configuration) into contact with a base of the partially formed receptacle such that the expandable member deforms toward a periphery of the base of the partially formed receptacle, and inserting fluid into the expandable member to expand the expandable member from the first configuration to a second configuration more expanded than the first configuration so as to urge the partially formed receptacle against an inner surface of the mould during a process to form the receptacle from the partially formed receptacle.

### CROSS-REFERENCE TO RELATED APPLICATIONS

This application is a continuation under 35 U.S.C. § 120 of International Application No. PCT/GB2023/051694, filed Jun. 29, 2023, which claims priority to United Kingdom Application No. GB 2209678.8, filed Jun. 30, 2022, under 35 U.S.C. § 119 (a). Each of the above-referenced patent applications is incorporated by reference in its entirety.

### TECHNICAL FIELD

The present invention relates to a method of moulding a receptacle and a mould system.

### BACKGROUND

It is desirable to reduce plastics use in consumable items, particularly packaging. Trays and other simple shapes are commonly made from paper pulp, but more complex objects, such as bottles, are more difficult to engineer. For example, it may be difficult to ensure compaction of paper pulp within a mould to form a bottle. Poor compaction may result in weak spots in the bottle.

### SUMMARY

According to a first aspect of the present invention, there is provided a method of moulding a receptacle. The method comprises providing a mould, providing a partially formed receptacle within the mould, providing an expandable member (in a first configuration) within the partially formed receptacle, moving the expandable member (in the first configuration) into contact with a base of the partially formed receptacle such that the expandable member deforms toward a periphery of the base of the partially formed receptacle, and inserting fluid into the expandable member to expand the expandable member from the first configuration to a second configuration more expanded than the first configuration so as to urge the partially formed receptacle against an inner surface of the mould during a process to form the receptacle from the partially formed receptacle.

For methods in which the expandable member is expanded to form the receptacle without first deforming the expandable member toward the periphery of the base of the partially formed receptacle, friction generated at the points at which the expandable member initially contacts the partially formed receptacle may inhibit further expansion of the expandable member into the periphery. This may result in poor compaction of the periphery, which may result in weak spots in the receptacle.

Alternatively, or additionally, this friction may result in non-uniform stretching of the expandable member. For example, portions of the expandable member which are not inhibited by the friction may stretch excessively to compensate for portions of the expandable member which are inhibited by the friction. This excessive stretching may damage or fatigue the expandable member. Deforming the expandable member toward the periphery prior to expanding the expandable member to form the receptacle may mitigate these factors. Specifically, the expandable member may be more likely to expand into the periphery of the base of the partially formed receptacle than a method in which the expandable member is not deformed toward the periphery prior to expanding the expandable member to form the receptacle. This may reduce the occurrence of weak spots in the receptacle caused by insufficient compaction of the material from which the receptacle is made. Additionally, or alternatively, the expandable member may be more likely to stretch in a uniform manner and thereby reduce the likelihood of damage or fatigue due to excessive stretching. Thereby, the longevity of the expandable member may be improved.

Optionally, the first configuration is the natural resting state of the expandable member (for example, a state in which no radially inward or outward pressure is applied to the expandable member, and/or a state in which no negative or positive pressure is applied to the inside of the expandable member). Alternatively, the first configuration is a state in which some positive pressure has been applied to an inside of the expandable member to expand the expandable member from its natural resting state.

Optionally, the receptacle is a bottle.

Optionally, the expandable member is moved into contact with the base such that a distance between the expandable member and the periphery of the base of the partially formed receptacle is no greater than 50% of a radius of the base of the partially formed receptacle. Thereby the portion of the expandable member which will expand into the periphery of the base of the partially formed receptacle will be located closer to the periphery than if the distance were greater than 50%. Thereby, the expandable member may be more likely to expand into the periphery of the base of the partially formed receptacle, and thereby the occurrence of weak spots in the receptacle may be reduced. Additionally, a pressure exerted by the expandable member on the partially formed receptacle when the expandable member expands to the second configuration may be more evenly distributed compared to if the distance were greater than 50%. Moreover, by the distance being no greater than 50%, strain within the expandable member may be reduced and thereby the longevity of the expandable member improved compared to if the distance were greater than 50%.

Optionally, the partially formed receptacle comprises a side and a corner which joins a portion of the periphery of the base of the partially formed receptacle to the side of the partially formed receptacle. Optionally, the corner of the partially formed receptacle has a first radius of curvature. Optionally, the expandable member comprises a corner which is adjacent to the corner of the partially formed receptacle prior to the inserting fluid into the expandable member to further expand the expandable member. Optionally, the expandable member is moved into contact with the base such that the corner of the expandable member has a second radius of curvature which is no greater than 130% and no less than 70% of the first radius of curvature. As a result, prior to expanding the expandable member to form the receptacle, the shape of the expandable member located adjacent to the corner of the partially formed receptacle is substantially the same as the corner of the partially formed receptacle. This may improve the likelihood of the expandable member conforming to the shape of the corner of the partially formed receptacle when expanded compared with a second radius outside of these values. This improved conformance may improve the compaction of the partially formed receptacle in the corner, which may thereby reduce he occurrence of weak spots.

Optionally, the expandable member is moved into contact with the base such that the second radius of curvature is no greater than 110% and no less than 90% of the first radius of curvature.

Optionally, prior to or during the moving the expandable member into contact with the base of the partially formed receptacle, there is a clearance between the expandable member and a side of the partially formed receptacle. Thereby, the likelihood of the expandable member rubbing against and damaging the side of the partially formed receptacle during the movement of the expandable member prior to expanding the expandable member to form the receptacle may be reduced compared with a method in which there is no clearance between the expandable member and the side of the partially formed receptacle.

Optionally, the clearance is measured along a clearance axis, and the clearance is no less than a thickness of a wall of the expandable member measured along the clearance axis. Thereby, the likelihood of rubbing may be reduced compared with a clearance of less than the thickness of the wall of the expandable member measured.

Optionally, the clearance is measured along the clearance axis, and the clearance is no greater than four times the thickness of the wall of the expandable member measured along the clearance axis. As a result, a wider expandable member may be used compared with a clearance of greater than four times the thickness of the wall of the expandable member, which may increase the likelihood of the expandable member being able to expand into the periphery of the base of the partially formed receptacle. Specifically, achieving a clearance of greater than four times the thickness of the wall of the expandable member may require that a thinner expandable member is used.

Optionally, the receptacle comprises a neck, and the expandable member is moved into contact with the base of the receptacle such that the expandable member deforms into contact with the neck of the receptacle. As a result, an area of high friction may be created between the neck and the expandable member which may anchor the expandable member relative to the receptacle. Thereby the likelihood of the expandable member moving away from the base of the receptacle during the subsequent expansion of the expandable member may be reduced when compared with a process where the neck is not contacted by the expandable member. This may improve the compaction of the base of the receptacle and thereby reduce the likelihood of weak spots in the receptacle.

Optionally, the mould comprises an opening. Optionally, the providing an expandable member, in a first configuration, within the partially formed receptacle comprises providing the expandable member outside of the mould in a third configuration in which the expandable member is less expanded than when in the first configuration, inserting the expandable member in the third configuration into the mould via the opening, and inserting fluid into the expandable member to expand the expandable member from the third configuration to the first configuration. Inserting the expandable member in the third (less expanded) configuration may enable a wider expandable member to be inserted into the partially formed receptacle without damaging the expandable member or the partially formed receptacle during insertion when compared with inserting the expandable member in the first configuration. A wider expandable member may improve the likelihood of the expandable member expanding into the periphery, and thereby the occurrence of weak spots in the receptacle may be reduced.

Subsequently expanding the expandable member from the third configuration to the first configuration may increase the extent to which the expandable member can deform toward the periphery of the base of the receptacle. For example, if the expandable member was collapsed to enable insertion into the opening and was not subsequently expanded prior to contacting the base of the receptacle, the collapsed expandable member may be less likely to deform toward the periphery of the base of the receptacle.

Optionally, the method comprises withdrawing the expandable member from the mould via the opening after the process to form the receptacle from the partially formed receptacle. Thereby, the expandable member may be reused to mould multiple receptacles, which may reduce the cost of a moulding process employing the method.

Optionally, when in the third configuration, a negative pressure is applied to an inside of the expandable member such that the expandable member is collapsed.

Optionally, the method comprises providing a mandrel which is at least partially located inside the expandable member. Providing a mandrel may provide structural support to the expandable member which may aid in appropriately locating the expandable member prior to expanding the expandable member to form the receptacle. Thereby the likelihood of the expandable member expanding into the periphery of the base of the partially formed receptacle during expansion of the expandable member to form the receptacle may increase compared with a method in which a mandrel is not provided.

Optionally, the mandrel comprises one or more holes through which the fluid is flowable from an interior of the mandrel to an exterior of the mandrel to expand the expandable member.

Optionally, the method comprises at least one of rotating the mandrel relative to the mould to twist the expandable member around the mandrel to reduce a width of the expandable member, and rotating the mandrel relative to the mould to untwist the expandable member from around the mandrel to increase the width of the expandable member. As a result, the width of the expandable member may be varied. Thereby, the width of the expandable member may be reduced to facilitate passage of the expandable member through the opening and then increased to enable the expansion of the expandable member to form the receptacle. Beneficially, this may enable a wider expandable member to be employed than would be possible without twisting the expandable member. A wider expandable member may improve the likelihood of the expandable member expanding into the periphery, and thereby the occurrence of weak spots in the receptacle may be reduced.

Optionally, the expandable member is attached to the mandrel, the method comprises providing a connector for connecting the mandrel to the mould, the expandable member is attached to the connector, and the rotation of the mandrel is relative to the connector.

Optionally, the method comprises moving the mandrel to vary a width of the expandable member. Thereby, the width of the expandable member may be reduced, to facilitate passage of the expandable member through the opening, and then increased to enable the expansion of the expandable member to form the receptacle. Beneficially, this may enable a wider expandable member to be employed than would be possible without varying the width of the expandable member. A wider expandable member may improve the likelihood of the expandable member expanding into the periphery, and thereby the occurrence of weak spots in the receptacle may be reduced.

Optionally, the expandable member is attached to the mandrel, the method comprises providing a connector for connecting the mandrel to the mould, the expandable member is attached to the connector, and the mandrel is moveable relative to the connector.

Optionally, the partially formed receptacle is formed, at least partially, of paper pulp. The choice of paper is ecologically more friendly than plastic. However, in being formed of paper pulp, the receptacle is particularly susceptible to weak spots due to insufficient compaction. By deforming the expandable member toward the periphery of the base of the partially formed receptacle prior to the expansion of the expandable member to form the receptacle, the expandable member may be more likely to expand into the periphery than a method in which the expandable member is not deformed toward the periphery prior to the expansion of the expandable member to form the receptacle. This may reduce the likelihood of weak spots in the receptacle due to insufficient compaction occurring.

Optionally, the method comprises applying heat to the partially formed receptacle during the inserting fluid into the expandable member to further expand the expandable member. Thereby a thermoforming operation is applied to the partially formed receptacle. Thermoforming may improve the mechanical properties of the receptacle, such as stiffness, as well as the surface finish of the receptacle.

Optionally, the partially formed receptacle is formed at least partially of paper pulp, the mould is heated to heat the partially formed receptacle, and a duration of time between the moving the expandable member into contact with the base of the partially formed receptacle and the inserting fluid into the expandable member to expand the expandable member from the first configuration to the second configuration is no greater than 1 second. As the expandable member contacts the base of the partially formed receptacle, some of the paper pulp of the base may be pushed into the mould by the expandable member. Due to the mould being heated, the water in the paper pulp of the base may flash into steam. The steam may apply pressure to the outside of the base of the receptacle. If the expandable member is only in the first configuration when this flashing occurs, the expandable member may be unable to apply sufficient pressure to the inside of the base of the receptacle to oppose the pressure applied by the steam. This may result in the paper pulp becoming damaged which may lead to weak spots in the receptacle. By expanding the expandable member less than 1 second after moving the expandable member into contact with the base, the expandable member may have been expanded in time to apply sufficient pressure to oppose the pressure exerted by the steam and thereby reduce the likelihood of this damage occurring when compared with a longer duration between the operations.

Optionally, the duration is no greater than 0.9 seconds. Optionally, the duration is no greater than 0.75 seconds. Optionally, the duration is no greater than 0.5 seconds.

According to a second aspect of the present invention, there is provided a receptacle obtainable or obtained from a fabrication method comprising the method according to the first aspect of the present invention.

Optionally, the fabrication method comprises at least one additional process. Optionally, the at least one additional process comprises coating and drying the receptacle to produce a coated receptacle. Optionally, the at least one additional process comprises applying a closure to the receptacle or to the coated receptacle.

Optionally, the receptacle is a bottle.

According to a third aspect of the present invention, there is provided a mould system comprising a mould for receiving a partially formed receptacle, an expandable member, a pump fluidically connected to the expandable member, and a controller. When the expandable member is in a first configuration and provided within the partially formed receptacle, the controller is configured to cause the expandable member to move into contact with a base of the partially formed receptacle such that the expandable member deforms toward a periphery of the base of the partially formed receptacle, and cause the pump to insert fluid into the expandable member to expand the expandable member from the first configuration to a second configuration more expanded than the first configuration so as to urge the partially formed receptacle against an inner surface of the mould during a process to form the receptacle from the partially formed receptacle.

Optionally, the partially formed receptacle is a partially formed bottle.

Optionally, the first configuration is the natural resting state of the expandable member (for example, a state in which no radially inward or outward pressure is applied to the expandable member, and/or a state in which no negative or positive pressure is applied to the inside of the expandable member). Alternatively, the first configuration is a state in which some positive pressure has been applied to an inside of the expandable member to expand the expandable member from its natural resting state.

Optionally, the controller is configured to cause the expandable member to be inserted in a third configuration, in which the expandable member is less expanded than when in the first configuration, into the mould via an opening of the mould, and cause the pump to insert fluid into the expandable member to expand the expandable member from the third configuration to the first configuration. Inserting the expandable member in the third (less expanded) configuration may enable a wider expandable member to be inserted into the partially formed receptacle without damaging the expandable member or the receptacle during insertion when compared with inserting the expandable member in the second configuration. A wider expandable member may improve the likelihood of the expandable member expanding into the periphery, and thereby the occurrence of weak spots in the receptacle may be reduced.

Optionally, when in the third configuration, a negative pressure is applied to an inside of the expandable member such that the expandable member is collapsed.

Optionally, the controller is configured to cause the pump to insert fluid into the expandable member to expand the expandable member from the third configuration to the first configuration such that there is a clearance between the expandable member and a side of the partially formed receptacle.

Optionally, the clearance is measured along a clearance axis, and the clearance is no less than a thickness of a wall of the expandable member measured along the clearance axis. Optionally, the clearance is measured along the clearance axis, and the clearance is no greater than four times the thickness of the wall of the expandable member measured along the clearance axis.

Optionally, the controller is configured to cause the expandable member to move into contact with the base of the partially formed receptacle such that a distance between the expandable member and the periphery of the base of the partially formed receptacle is no greater than 50% of a radius of the base of the partially formed receptacle.

Optionally, the partially formed receptacle comprises a side and a corner which joins a portion of the periphery of the base of the partially formed receptacle to the side of the partially formed receptacle. Optionally, the corner of the partially formed receptacle has a first radius of curvature. Optionally, the expandable member comprises a corner which is adjacent to the corner of the partially formed receptacle prior to the controller causing the pump to insert fluid into the expandable member to expand the expandable member. Optionally, the controller is configured to cause the expandable member to move into contact with the base of the partially formed receptacle such that the corner of the expandable member has a second radius of curvature which is no greater than 130% and no less than 70% of the first radius of curvature.

Optionally, the expandable member is moved into contact with the base such that the second radius of curvature is no greater than 110% and no less than 90% of the first radius of curvature.

Optionally, the mould system comprises a mandrel which is at least partially located or partially locatable inside the expandable member.

Optionally, the mandrel is rotatable relative to the expandable member to twist the expandable member around the mandrel.

Optionally, the mould system comprises a connector for connecting the mandrel to the mould, the expandable member is attached to the connector, and the mandrel is rotatable relative to the connector.

Optionally, the mandrel is moveable to vary a width of the expandable member.

Optionally, the mould system comprises a connector for connecting the mandrel to the mould, the expandable member is attached to the connector, and the mandrel is moveable relative to the connector.

Optionally, the mould system comprises a heater; and the controller is configured to cause the heater to apply heat to the partially formed receptacle during the insertion of fluid into the expandable member to expand the expandable member from the first configuration to the second configuration.

Optionally, the mould system is a paper pulp receptacle mould system.

According to a fourth aspect of the present invention, there is provided a non-transitory storage medium storing machine-readable instructions that, when executed by a processor of a mould system comprising a mould and an expandable member, in a first configuration, located within a partially formed receptacle, cause the processor to cause the expandable member to move into contact with a base of the partially formed receptacle such that the expandable member deforms toward a periphery of the base of the partially formed receptacle, and cause fluid to be inserted into the expandable member to expand the expandable member from the first configuration to a second configuration more expanded than the first configuration so as to urge the partially formed receptacle against an inner surface of the mould during a process to form the receptacle from the partially formed receptacle.

Optionally, the partially formed receptacle is a partially formed bottle.

Optional features of aspects of the present invention may be equally applied to other aspects of the present invention, where appropriate.

### BRIEF DESCRIPTION OF DRAWINGS

Embodiments of the invention will now be described, by way of example only, with reference to the accompanying drawings, in which:

FIG. 1 is a schematic view of an example process for making bottles from paper pulp;

FIG. 2 shows a simplified section view of an example mould system;

FIG. 3 shows, by way of simplified sections, different stages in the operation of the mould system, wherein (a) a mandrel system of the mould system is located outside a mould of the mould system and an expandable member of the mandrel system is in a third configuration; (b) a mandrel of the mandrel system is moved relative to a connector of the mandrel system to decrease the width of an expandable member; (c) the mandrel system is inserted into the mould; and (d) the expandable member is expanded from the third configuration to a first configuration;

FIG. 4 shows, by way of simplified section, the expandable member being moved into contact with a base of a partially formed receptacle located within the mould such that the expandable member deforms;

FIG. 5 shows an enlarged view of the expandable member being moved into contact with the base of the partially formed receptacle; and

FIG. 6 shows, by way of simplified sections, different stages in the operation of the mould system, wherein (a) the expandable member is expanded from the first configuration to a second configuration to apply a forming operation to the partially formed receptacle; (b) the expandable member is collapsed from the second configuration to the third configuration; (c) the connector and the mandrel are moved to reduce the width of the expandable member; and (d) the mandrel system is withdrawn from the mould.

### DETAILED DESCRIPTION

The following description presents exemplary embodiments and, together with the drawings, serves to explain principles of embodiments of the invention.

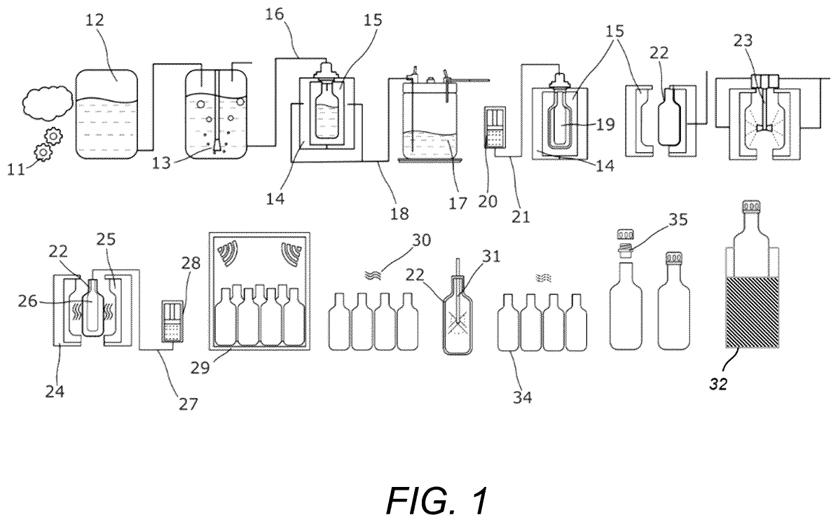

FIG. 1 shows a process for making bottles from paper pulp (i.e., which can form the basis of an example fibre suspension). The process is merely exemplary and is provided to give context to examples of the present invention. Broadly speaking, the exemplary process comprises providing a fibre suspension, introducing the fibre suspension into a mould cavity of a porous first mould and using the porous first mould to expel a liquid (such as water) from the fibre suspension to produce a wet precursor or embryo (which may itself be considered a moulded receptacle), further moulding the wet precursor in a mould to produce a further-moulded receptacle, coating the further-moulded receptacle to produce a coated moulded receptacle, drying the coated moulded receptacle to produce a dried receptacle, and applying a closure to the dried receptacle. As will be apparent at least from the following description, modifications may be made to the exemplary process to provide variants thereof in which other examples of the present invention may be embodied.

In this example, providing the fibre suspension comprises preparing the fibre suspension from ingredients thereof. More specifically, the preparing comprises providing pulp fibres, such as paper pulp fibres, and mixing the pulp fibres with a liquid to provide hydrated pulp fibres. In this example, the pulp fibres are provided in sheet form from a supplier and the liquid comprises water and one or more additives. In this example, the liquid is mixed with the pulp fibres to provide hydrated pulp fibres having a solid fibres content of 1 wt % to 5 wt % (by dry mass of fibres). In examples, the one or more additives includes a sizing agent, such as alkylketene dimer (AKD). The hydrated pulp fibres typically comprise AKD in an amount of 0.4 wt % with respect to the total dry mass of the solid fibres in the hydrated pulp fibres. In some examples, one or more additives are present in the liquid at the point of mixing the pulp fibres with the liquid. In some examples, one or more additives are included in the hydrated pulp fibres after mixing the pulp fibres with the liquid (e.g. the pulp fibres are hydrated for a period of time, such as from 2 to 16 hours, and then one or more additives are supplied to the hydrated pulp fibres). The hydrated pulp fibres are passed between plates of a valley beater 11 or refiner that are in motion relative to each other. This fibrillates some, or all, of the fibres, meaning that cell walls of those fibres are caused to become partially delaminated so that wetted surfaces of those fibres comprise protruding hairs or fibrillations. These fibrillations will help to increase a strength of bonds between the fibres in the dried end product. In other examples, the valley beater 11 or refiner may be omitted.

The resultant processed pulp is stored in a vat 12 in a relatively concentrated form (e.g. a solid fibres content of 1 wt % to 5 wt %) to reduce a required storage space. At an appropriate time, the processed pulp is transferred to a mixing station 13 at which the processed pulp is diluted in further water and, optionally, mixed with one or more additives (as well as, or in place of, the one or more additives provided with the hydrated pulp fibres) to provide the fibre suspension ready for moulding. In this example, the solid fibres account for 0.7 wt % of the resultant fibre suspension (by dry weight of fibres), but in other examples the proportion of solid fibres in the fibre suspension may be different, such as another value in the range of 0.5 wt % to 5 wt %, or 0.1 wt % to 1 wt %, of the fibre suspension (by dry weight of fibres). In some examples, the one or more additives mixed with the processed pulp and water includes a dewatering agent, such as modified and/or unmodified polyethylene imine (PEI), e.g. modified PEI sold under the trade name Polymin® SK. In some examples, the one or more additives are mixed with the water, and the water and one or more additives subsequently mixed with the processed pulp; in other examples, the processed pulp and water are mixed, and the one or more additives subsequently mixed with the processed pulp and water. The fibre suspension typically comprises Polymin® SK in an amount of 0.3 wt % with respect to the total dry mass of the solid fibres. Mixing of the fibre suspension at the mixing station 13 helps to homogenise the fibre suspension. In other examples, the processed pulp or the fibre suspension may be provided in other ways, such as being supplied ready-made.

In this example, the porous first mould 15 comprises two half-moulds that are movable toward and away from each other, in this case using a hydraulic ram. In this example, each of the half-moulds is a monolithic or unitary tool formed by additive manufacturing (e.g. 3D-printing) that defines a mould profile, and, when the half-moulds are brought into contact with each other, their respective mould profiles cooperate to define the mould cavity in which the wet precursor or moulded receptacle is to be formed. Each half-mould may itself define a smaller moulding cavity and, when brought into cooperation with a second half-mould, the smaller moulding cavities may combine to provide the overall mould cavity. The two half-moulds may themselves be considered “splits” or “moulds” and the overall porous first mould 15 may be considered a “split-mould” or, again, a “mould”. In other examples, the porous first mould 15 may comprise more than two splits, such as three, four or six splits, that cooperate to define the moulding cavity.

In FIG. 1, the fibre suspension (also known as slurry) is top-filled into the porous mould 15, in contrast to moulding processes that dip a mould in slurry. The fibre suspension is drawn under vacuum via a line 16 and into the porous mould 15, with excess suspending liquid being drawn through the porous mould 15 under vacuum via a line 18 into a tank 17. Shot mass may be controlled by measuring (e.g., weighing) the amount of liquid drawn into the tank 17. A weight scale platform supporting the tank 17 is visible in FIG. 1. Once a required amount (e.g. a predetermined volume, such as 10 litres, or a predetermined mass, such as 10 kilograms) of liquid has been collected in the tank 17, suction of the suspending liquid through the porous mould 15 is stopped and the porous mould 15 is opened to ambient air. In this example, the suspending liquid drawn with the fibre suspension in line 16 is water, or predominantly water (as additives may also be present). The liquid drawn under vacuum via the line 18 and into the tank 17 is substantially free of fibres, since these are left behind against the walls of the porous mould 15 to form an embryo of the moulded receptacle.

In one form, in order to remove further suspending liquid (e.g. water) from the embryo, and form or consolidate the three-dimensional shape of the receptacle, an impermeable inflation element 19, e.g., a collapsible bladder, is inserted into the porous mould 15 and expanded to act as an internal high-pressure core structure for the porous mould 15. This process strengthens the wet embryo so that it can be handled, and displaces water from in between the fibres, thereby increasing the efficiency of a subsequent drying process. The inflation element 19 is actuated and regulated using a hydraulic pump 20. The pump 20 has a cylinder that displaces a fluid in a line 21 into the inflation element 19, to expand the inflation element 19 radially and into conformity with the mould cavity. Fluid within the line 21 is preferably non-compressible, such as water. Water also has the advantage over other non-compressible liquids that any leaking or bursting of the bladder 19 will not introduce a new substance to the system (since the suspending liquid is already water, or predominantly water).

Demoulding occurs when the porous mould 15 opens for removal of the self-supporting moulded receptacle 22. Mould cleaning 23 is preferably performed subsequently, to remove small fibres and maintain a porosity of the porous mould 15. In this example, a radially firing high-pressure jet is inserted into the mould cavity while the mould 15 is open. This dislodges fibres from the wall of the mould cavity. Alternatively, or in addition, water from the tank 17 is pressurised through the back of the porous mould 15 to dislodge entrapped fibres. Water is drained for recycling back to an upstream part of the system. It is noteworthy that cleaning is important for conditioning the porous mould 15 for re-use. The porous mould 15 may appear visibly clean after removal of the receptacle, but its performance could be compromised without cleaning.

According to FIG. 1, the formed but unfinished receptacle 22 is subsequently transported to a second moulding station where, in a, e.g., aluminium, mould 25, pressure and heat are applied for thermoforming a desired neck and surface finish, optionally including embossed and/or debossed surface features. After two halves of the mould 25 have closed around the receptacle 22, a pressuriser is engaged. For example, a bladder 26 (e.g., a thermoforming bladder 26) is inserted into the receptacle 22. The bladder 26 is inflated via a line 27 by a pump 28 to supply pressurised fluid, e.g., air, water, or oil. Optionally, during supply, the pressurised fluid is heated with e.g. a heater or, alternatively, is cooled with e.g. a heat exchanger. An external mould block 24 of the mould 25, and/or the mould 25 itself, may also, or alternatively, be heated. A state of the moulded receptacle 22 after thermoforming is considerably more rigid, with more compressed side walls, compared with the state at demoulding from the porous mould 15.

A drying stage 29 (e.g. a microwave drying process or other drying process) is performed downstream of the thermoforming, as shown. In one example, the drying stage 29 is performed before thermoforming. However, moulding in the mould 25 requires some water content to assist with bonding during the compression process. FIG. 1 illustrates a further drying stage 30 after the drying stage 29, which may utilise hot air circulated onto the moulded receptacle 22, e.g., in a “hot box”. In some examples, microwave or other drying processes may be performed at plural stages of the overall manufacturing process.

The moulded receptacle 22 is then subjected to a coating stage during which, in this example, a spray lance 31 is inserted into the moulded receptacle 22 and applies one or more surface coatings to internal walls of the moulded receptacle 22. In another example, the moulded receptacle 22 is instead filled with a liquid that coats the internal walls of the moulded receptacle 22. In practice, such coatings provide a protective layer to prevent egress of contents into the bottle wall, which may permeate and/or weaken it. Coatings will be selected dependent on the intended contents of receptacle 22, e.g., a beverage, detergent, pharmaceutical product, etc. In some examples, the further drying stage 30 is performed after the coating stage (or both before and after the coating stage). In this example, the moulded receptacle 22 is then subjected to a curing process 34, which can be configured or optimised dependent on the coating, e.g., drying for twenty-four hours at ambient conditions or by a flash drying method. In some examples, e.g. where the further drying stage 30 occurs after the coating stage, the curing process 34 may be omitted.

At an appropriate stage of production (e.g., during thermoforming, or before or after coating) a closure or mouth forming process may be performed on the moulded receptacle 22. For example, as shown in FIG. 1, a neck fitment 35 may be affixed. In some examples, an exterior coating is applied to the moulded receptacle 22, as shown in the further coating stage 32. In one example, the moulded receptacle 22 is dipped into a liquid that coats its outer surface, as shown in FIG. 1. One or more further drying or curing processes may then be performed. For example, the moulded receptacle 22 may be allowed to dry in warm air. The moulded receptacle 22 may therefore be fully formed and ready to accept contents therein.

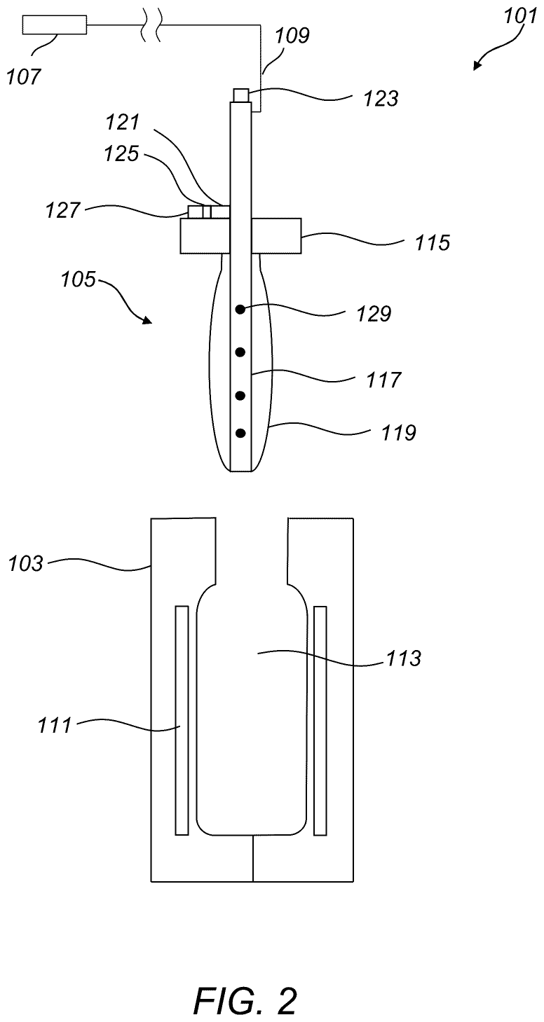

FIG. 2 shows a mould system 101 which may be used to thermoform the self-supporting moulded receptacle 22 discussed above. The mould system comprises a mould 103, a mandrel system 105, a pump 107 and a line 109.

The mould 103 comprises a first part and a second part. In other examples, the mould may comprise more than two parts. The two parts are separable so as to open the mould 103. Each part comprises a cavity and a heater 111. When the two parts are brought together to close the mould 103, a mould cavity 113 is created within the mould 103 that comprises the cavities of the first part and the second part. The mould comprises an opening to the mould cavity 113. The heaters 111 are operable to heat the two parts of the mould and thereby heat the mould cavity 113.

The mandrel system 105 comprises a connector 115, a mandrel 117, an expandable member 119, a first actuator 121, a second actuator 123, a flash memory 125 and a controller 121.

The connector 115 comprises a bore that extends through the connector 115 from a top to a bottom of the connector 115. An annular seal is located within the bore and provides a seal between the connector 115 and the mandrel 117. The seal is a low-friction seal and permits movement of the mandrel 117 relative to the connector 115. As described below in more detail, the mandrel 117 moves relative to the connector 115 when inserting and withdrawing the mandrel 117 and expandable member 119 from the mould 103.

The mandrel 117 comprises a cylindrical tube. A plurality of holes 129 are formed along the length of the tube. The holes 129 are located along a lower portion of the tube and extend radially through the tube to allow fluid to flow from the interior of the mandrel 117 to the exterior of the mandrel 117. The mandrel 117 extends through the bore in the connector 115 and into the expandable member 119 such that a lower portion of the mandrel 117 is located within the expandable member 119. In some examples, the mandrel 117 may be fully located inside the expandable member 119 and a different connector 115 may be used. A lower end of the mandrel 117, i.e., the end of the mandrel 117 located within the expandable member 119, is disconnectably connected to the expandable member (for example, by a pair of magnets). The mandrel 117 is free to move relative to the connector 115. In particular, the mandrel 117 is free to move up and down within the bore, and to rotate within the bore.

The expandable member 119 comprises an inflatable member in the form of an elastomeric bladder. The bladder comprises a neck portion and a body portion. The neck portion is sealingly connected to the bottom of the connector 115. The neck portion has a smaller diameter than the body portion. In other examples, the bladder may comprise a single portion of constant diameter.

The first actuator 121 is located on the connector 115 and is coupled to the mandrel 117. Operation of the first actuator 121 causes the mandrel 117 to move linearly, relative to the connector 115, along the longitudinal axis of the mandrel 117. In this example, the first actuator 121 comprises an electric motor and a transmission (e.g., gears, friction wheel, and/or rack and pinion) for transmitting torque generated by the electric motor to the mandrel 117. In other examples, the first actuator 121 may comprise a hydraulic or pneumatic system for moving the mandrel 117 relative to the connector 115.

The second actuator 123 is located at a top end of the mandrel 117 and is coupled to the mandrel 117. Operation of the second actuator 123 causes the mandrel 117 to rotate, relative to the connector 115, about the longitudinal axis of the mandrel 117. In this example, the second actuator 123 comprises an electric motor and a transmission (e.g., gears, friction wheel, and/or rack and pinion) for transmitting torque generated by the electric motor to the mandrel 117. In other examples, the second actuator 123 may comprise a hydraulic or pneumatic system for rotating the mandrel 117 relative to the connector 115.

The flash memory 125 stores computer readable instructions for execution by the controller 127 (which may be considered a processor) in operation. In other examples, other types of memory may be used.

The controller 127 controls the operation of the actuators 121,123 and thereby the movement of the mandrel 117 relative to the connector 115. The controller 127 also controls the pump 107, the heaters 111, and a robotic arm (not shown), which moves the connector 115 relative to the mould 103.

The pump 107 comprises a cylinder which displaces a fluid in the line 109. In some examples, the fluid is one of air, water, or oil. As the line 109 is connected to the top of the mandrel 117, displacing the fluid causes the pump 107 to supply a pressurised fluid to the interior of the mandrel 117. The pressurised fluid then flows through the holes 129 in the mandrel 117 and into the expandable member 119. Thereby, the pump 107 is used to expand the expandable member 119. The pump 107 is also capable of operating in the opposite direction to withdraw the fluid from the expandable member 119 and thereby collapse and contract the expandable member 119.

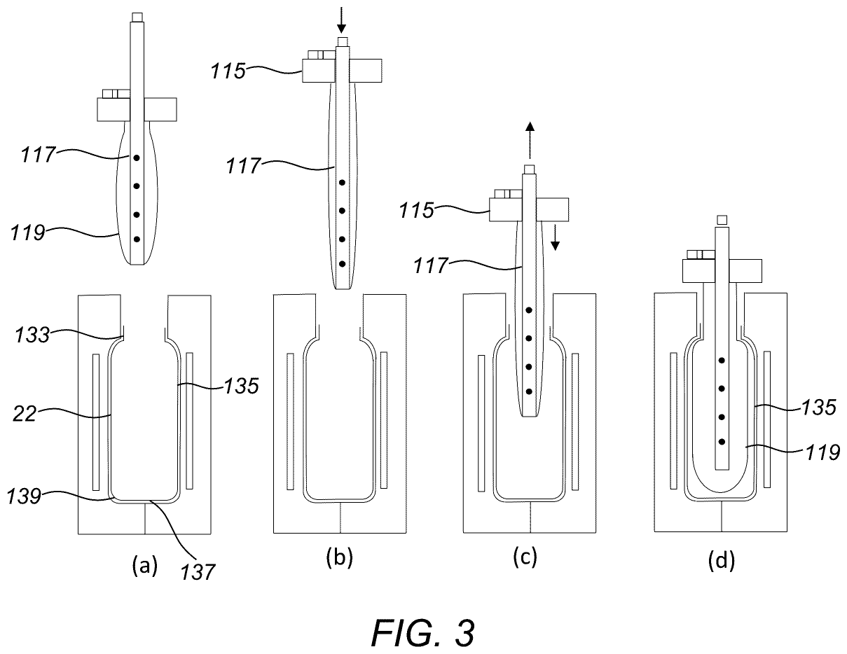

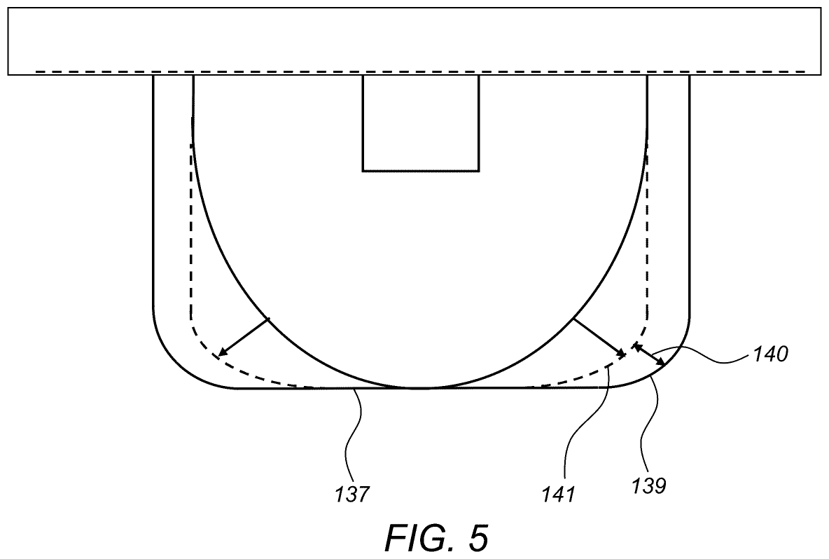

Use of the mould system 101 will now be described with reference to FIGS. 3 to 6. The controller 127 controls the heaters 11 to heat the two parts of the mould 103. As shown in FIG. 3(a), the two parts of the mould 103 are then closed around a partially formed receptacle 22 such that the partially formed receptacle 22 is located inside the mould cavity 113. The partially formed receptacle 22 has the shape of a bottle and comprises a main body and a neck 133. The neck 115 has a smaller diameter than the main body. The main body comprises a side 135 with a cylindrical shape which is joined to a base 137 of the main body by a corner 139. At this stage, the mandrel system 105 is located outside of the mould cavity 113 and the expandable member 119 is connected to the mandrel 117. Additionally, the expandable member 119 is in a natural resting state. I.e., a state in which no negative or positive pressure is applied by the pump 107 to an inside of the expandable member 119.

Turning now to FIG. 3(b), the controller 127 controls the first actuator 127 to move the mandrel 117 down relative to the connector 115. As the mandrel 117 moves down, the end of the mandrel 117 forces the bottom of the expandable member 119 down, which increases the length of the expandable member 119. This increase in length of the expandable member 119 results in a corresponding reduction in the width of the expandable member 119. Concurrently, the controller 127 operates the second actuator 123 to rotate the mandrel 117 relative to the connector 115. Due to the expandable member 119 being attached to the end of the mandrel 117, the rotation causes the expandable member 119 to twist around the mandrel 117 and further reduce the width of the expandable member 119.

The controller 127 then controls the actuators 121,123 to halt the downward motion and rotation of the mandrel 117. At this stage, the width of the expandable member 119 is less than the width of the opening of the mould 103. Thereby, the mandrel 117 and expandable member 119 may pass through the opening of the mould 103 without the expandable member 119 contacting the mould 103 or the partially formed receptacle 22.

Turning now to FIG. 3(c), the controller 127 then controls the robotic arm to move the connector 115 down and toward the mould 103. As the connector 115 moves down, the mandrel 117 and the expandable member 119 are inserted into the mould cavity 113 through the opening. Due to the previous downward motion of the mandrel 117 relative to the connector 115 (discussed with reference to FIG. 3(b)), the length of the mandrel 117 is too great to fit within the mould cavity 113. Therefore, once a predetermined length of the mandrel 117 has been inserted into the mould cavity 113, the controller 127 operates the first actuator 121 to move the mandrel 117 up relative to the connector 115. The upward movement of the mandrel 117 relative to the connector 115 causes the length of the expandable member 119 to decrease and the width of the expandable member 119 to increase.

The controller 127 then operates the second actuator 123 to rotate the mandrel 117 relative to the connector 115 to untwist the expandable member 119 from around the mandrel 117. This then causes the width of the expandable member 119 to further increase.

Turning now to FIG. 3(d), with the expandable member 119 now positioned within the mould cavity 113, the controller 127 controls the pump 107 to supply pressurised fluid to the mandrel which flows through the holes 129 in the mandrel 117 and into the expandable member 119 to expand the expandable member 119 from the natural resting state to a partially expanded state in which some positive pressure has been applied by the pump 107 to the inside of the expandable member The expansion of the expandable member 119 disconnects the expandable member from the end of the mandrel 117. The controller 127 halts the expansion of the expandable member 119 when the expandable member 119 has expanded to between 105% and 125% of its natural resting state. At this stage there is a clearance between the expandable member 119 and the side 135 of the main body of the partially formed receptacle 22. The clearance is measured along a clearance axis and is between one and four times a thickness of a wall of the expandable member measured along the clearance axis.

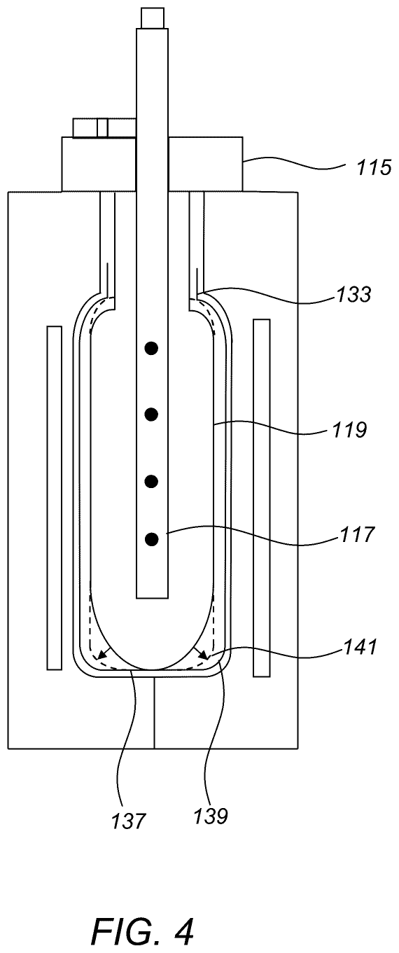

Turning now to FIG. 4, with the expandable member 119 now in the partially expanded state, the controller 127 controls the robotic arm to move the connector 115 down and into contact with the top of the mould 103. As the connector 115 moves down, the expandable member 119 moves down and into contact with the base 137 of the partially formed receptacle 22. This movement causes the expandable member 119 to be deformed against the base 139 of the partially formed receptacle 22, as shown by the dotted lines in FIG. 4. The expandable member 119 deforms toward a periphery of the base 137 of the partially formed receptacle 22 (i.e., toward the corner 139 of the main body of the partially formed receptacle 22). Once deformed, a distance 140 between the expandable member 119 and the periphery of the base 139 of the partially formed receptacle 22 is no greater than 50% of a radius of the base 137 of the partially formed receptacle 22.

Additionally, once deformed, a radius of a corner 141 of the expandable member 119 which is adjacent to the corner 139 of the partially formed receptacle 22 is no greater than 130% and no less than 70% of a radius of the corner 139 of the main body of the partially formed receptacle 22. In other examples, the radius of the corner 141 of the expandable member 119 is no greater than 110% and no less than 90% of the radius of the corner 139 of the of the main body of the partially formed receptacle 22.

Due to the Poisson effect, the deformation of the expandable member against the base of the partially formed receptacle causes other parts of the expandable member to undergo associated deformation. Specifically, the movement of the expandable member 119 into contact with the base 137 of the partially formed receptacle 22 also causes the expandable member 119 to deform into contact with the neck 133 of the partially formed receptacle 22. i.e., once deformed the expandable member 119 is in contact with the neck 133 of the partially formed receptacle 22.

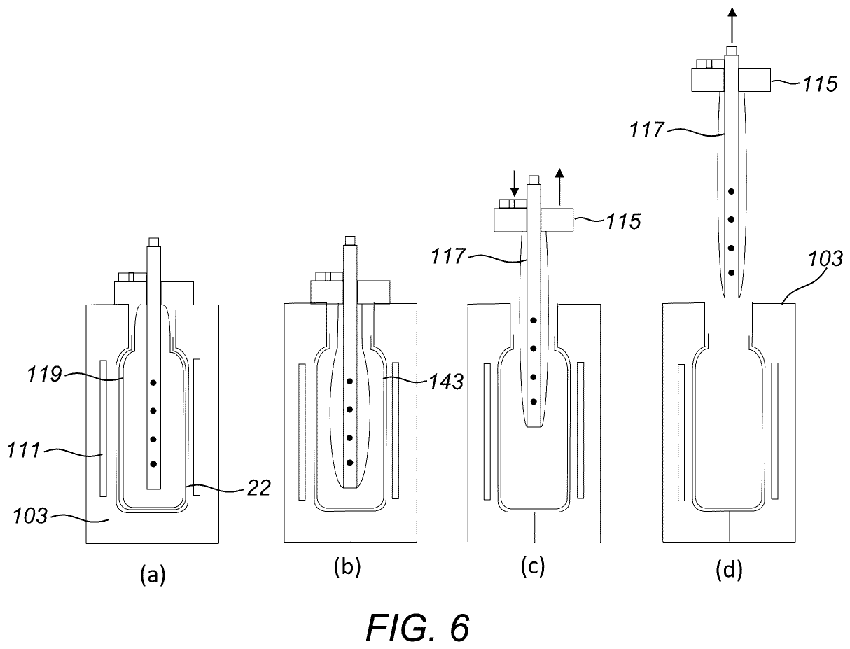

After a duration of less than 1 second from the expandable member 119 first contacting the base 137 of the partially formed receptacle 22, a forming operation is performed on the partially formed receptacle 22 (FIG. 6(a)). The controller 127 controls the pump 107 to supply the pressurised fluid to the mandrel 117 which flows through the holes 129 in the mandrel 117 and into the expandable member 119 to further expand the expandable member 119 from the partially expanded state to a more expanded state in which the expandable member 119 contacts other parts of the partially formed receptacle 22 (e.g., the side 135 of the main body) and urges the partially formed receptacle 22 against an inner surface of the mould 103. In this example, the partially expanded state is a first configuration, the more expanded state is a second configuration, and the natural resting state is a third configuration. As the controller 127 has previously controlled the heaters 111 to heat the two parts of the mould 103, the partially formed receptacle 22 is heated. Thereby, the partially formed receptacle 22 is heated and compressed such that a receptacle 143 is formed from the partially formed receptacle 22.

Turning now to FIG. 6(b), once the forming operation is complete, the controller 127 controls the pump 107 to withdraw the pressurised fluid from the expandable member 119, which causes the expandable member 119 to collapse and contract from the more expanded state to the natural resting state. As the expandable member 119 contracts, the expandable member 119 reconnects with the end of the mandrel 117.

The controller 127 then controls the robotic arm to move the connector 115 upwards relative to the mould 103 (FIG. 6(c)). Concurrently, the controller 127 controls the first actuator 121 to move the mandrel 117 downwards relative to the connector 115 at the same rate that the connector 115 is moved upwards, such that the end of the mandrel 117 is stationary relative to the mould 103. Thereby, the length of the expandable member 119 is increased, which results in the width of the expandable member 119 being decreased. The controller 127 also controls the second actuator 123 to rotate the mandrel 117 relative to the connector such that the expandable member 119 is twisted around the mandrel 117 to further decrease the width of the expandable member 119. With the expandable member 119 elongated and twisted around the mandrel 117, the controller 127 controls the actuators 121,123 to halt movement of the mandrel 117 relative to the connector 115.

Turning now to FIG. 6(d), the controller 127 controls the robotic arm to move the connector 115 upwards relative to the mould 103 to withdraw the mandrel 117 and expandable member 119 from the mould 103 via the opening. Once the mandrel 117 and expandable member 119 are withdrawn from the mould 103, the mould 103 is opened by separating the two parts of the mould 103 and the receptacle 143 removed for further processing. For example, the receptacle 143 may be dried in a drying stage 29, as described above with reference to FIG. 1.

For methods in which the expandable member 119 is expanded to form the receptacle 143 without first deforming the expandable member 119 toward the periphery of the base 137 of the partially formed receptacle 22, friction generated at the points at which the expandable member 119 initially contacts the partially formed receptacle 22 may inhibit further expansion of the expandable member 119 into the periphery. This may result in poor compaction of the periphery, which may result in weak spots in the receptacle 143.

Alternatively, or additionally, this friction may result in non-uniform stretching of the expandable member 119. For example, portions of the expandable member 119 which are not inhibited by the friction may stretch excessively to compensate for portions of the expandable member 119 which are inhibited by the friction. This excessive stretching may damage or fatigue the expandable member 119. Deforming the expandable member 119 toward the periphery prior to expanding the expandable member 119 to form the receptacle 143 may mitigate these factors. Specifically, the expandable member 119 may be more likely to expand into the periphery of the base 137 of the partially formed receptacle 22 than a method in which the expandable member 119 is not deformed toward the periphery prior to expanding the expandable member 119 to form the receptacle 143. This may reduce the occurrence of weak spots in the receptacle 143 caused by insufficient compaction of the material from which the receptacle 143 is made. Additionally, or alternatively, the expandable member 119 may be more likely to stretch in a uniform manner and thereby reduce the likelihood of damage or fatigue due to excessive stretching. Thereby, the longevity of the expandable member 119 may be improved.

In the above example, the third configuration is the natural resting state of the expandable member 119. However, in other examples, when in the third configuration, the pump 107 applies a negative pressure to the inside of the expandable member 119 such that the expandable member 119 is collapsed from its natural resting state. In these other examples, the first configuration is the natural resting state of the expandable member 119 or a state in which the expandable member 119 has been expanded from its natural resting state.

In the above examples, the forming operation is applied less than 1 second after the expandable member 119 has contacted the base 137 of the partially formed receptacle 22. In other examples, other durations may be used. For example, less than 0.9 seconds, less than 0.75 seconds or less than 0.5 seconds.

In the above example, the end of the mandrel 117 is disconnectably connected to the expandable member 119. However, in other examples, the end of the mandrel 117 may be permanently connected to the expandable member 119. In one example, once the expandable member 119 contacts the base 137 of the partially formed receptacle 22, the controller 127 controls the first actuator 121 to move the mandrel 117 upward at the same rate as the connector 115 is being moved down such that the mandrel 117 is stationary relative to the mould 103. In a second example, the first actuator 121 has an active and a passive mode. In the active mode the first actuator 121 moves the mandrel 117 relative to the connector 115, and in the passive mode the first actuator 121 is decoupled or idles such that the mandrel 117 is free to move relative to the connector 115. The first actuator 121 operates in the active mode to increase and decrease the length of the mandrel 117 and then operates in the passive mode during movement of expandable member 119 into contact with the base 137 of the partially formed receptacle 22 and expansion and contraction of the expandable member 119. In a third example, the mandrel 117 has a first and second telescopic part. The expandable member 119 is connected to the second telescopic part and the second telescopic part moves into and out of the first telescopic part to accommodate the movement and expansion of the expandable member 119. Equally, the mandrel 117 may be permanently disconnected from the expandable member 119 and the mandrel 117 may not rotate to twist the expandable member 119 around the mandrel 117.

Example embodiments of the present invention have been discussed, with reference to the example illustrated. However, it will be appreciated that variations and modifications may be made without departing from the scope of the invention as defined by the appended claims.

What is claimed is:

1. A method of moulding a receptacle, the method comprising:
providing a mould;
providing a partially formed receptacle within the mould;
providing an expandable member, in a first configuration, within the partially formed receptacle;
moving the expandable member, in the first configuration, into contact with a base of the partially formed receptacle such that the expandable member deforms toward a periphery of the base of the partially formed receptacle; and
inserting fluid into the expandable member to expand the expandable member from the first configuration to a second configuration more expanded than the first configuration so as to urge the partially formed receptacle against an inner surface of the mould during a process to form the receptacle from the partially formed receptacle.

2. The method of claim 1, wherein the expandable member is moved into contact with the base such that a distance between the expandable member and the periphery of the base of the partially formed receptacle is no greater than 50% of a radius of the base of the partially formed receptacle.

3. The method of claim 1, wherein:
the partially formed receptacle comprises a side and a corner which joins a portion of the periphery of the base of the partially formed receptacle to the side of the partially formed receptacle;
the corner of the partially formed receptacle has a first radius of curvature;
the expandable member comprises a corner which is adjacent to the corner of the partially formed receptacle prior to the inserting fluid into the expandable member to further expand the expandable member; and
the expandable member is moved into contact with the base such that the corner of the expandable member has a second radius of curvature which is no greater than 130% and no less than 70% of the first radius of curvature.

4. The method of claim 1, wherein, prior to or during the moving the expandable member into contact with the base of the partially formed receptacle, there is a clearance between the expandable member and a side of the partially formed receptacle.

5. The method of claim 4, wherein the clearance is measured along a clearance axis, and the clearance is no less than a thickness of a wall of the expandable member measured along the clearance axis.

6. The method of claim 4, wherein the clearance is measured along a clearance axis, and the clearance is no greater than four times a thickness of a wall of the expandable member measured along the clearance axis.

7. The method of claim 1, wherein:
the receptacle comprises a neck; and
the expandable member is moved into contact with the base of the receptacle such that the expandable member deforms into contact with the neck of the receptacle.

8. The method of claim 1, wherein:
the mould comprises an opening; and
the providing an expandable member, in a first configuration, within the partially formed receptacle comprises:
providing the expandable member outside of the mould in a third configuration in which the expandable member is less expanded than when in the first configuration;
inserting the expandable member in the third configuration into the mould via the opening; and
inserting fluid into the expandable member to expand the expandable member from the third configuration to the first configuration.

9. The method of claim 8, wherein the method comprises providing a mandrel which is at least partially located inside the expandable member.

10. The method of claim 9, wherein the method comprises moving the mandrel to vary a width of the expandable member.

11. The method of claim 1, wherein the partially formed receptacle is formed, at least partially, of paper pulp.

12. The method of claim 1, wherein the method comprises applying heat to the partially formed receptacle during the inserting fluid into the expandable member to further expand the expandable member.

13. The method of claim 12, wherein:
the partially formed receptacle is formed at least partially of paper pulp;
the mould is heated to heat the partially formed receptacle; and
a duration of time between the moving the expandable member into contact with the base of the partially formed receptacle and the inserting fluid into the expandable member to expand the expandable member from the first configuration to the second configuration is no greater than 1 second.

14. A receptacle produced by the process comprising:
providing a mould;
providing a partially formed receptacle within the mould;
providing an expandable member, in a first configuration, within the partially formed receptacle;
moving the expandable member, in the first configuration, into contact with a base of the partially formed receptacle such that the expandable member deforms toward a periphery of the base of the partially formed receptacle; and
inserting fluid into the expandable member to expand the expandable member from the first configuration to a second configuration more expanded than the first configuration so as to urge the partially formed receptacle against an inner surface of the mould during a process to form the receptacle from the partially formed receptacle.

15. The receptacle of claim 14, wherein the receptacle is a bottle.

16. A mould system comprising:
a mould for receiving a partially formed receptacle;
an expandable member;
a pump fluidically connected to the expandable member; and
a controller,
wherein, when the expandable member is in a first configuration and provided within the partially formed receptacle, the controller is configured to:
cause the expandable member to move into contact with a base of the partially formed receptacle such that the expandable member deforms toward a periphery of the base of the partially formed receptacle; and
cause the pump to insert fluid into the expandable member to expand the expandable member from the first configuration to a second configuration more expanded than the first configuration so as to urge the partially formed receptacle against an inner surface of the mould during a process to form the receptacle from the partially formed receptacle.

17. The mould system of claim 16, wherein the controller is configured to:
cause the expandable member to be inserted in a third configuration, in which the expandable member is less expanded than when in the first configuration, into the mould via an opening of the mould; and
cause the pump to insert fluid into the expandable member to expand the expandable member from the third configuration to the first configuration.

18. The mould system of claim 16, wherein:
the mould system comprises a heater; and
the controller is configured to cause the heater to apply heat to the partially formed receptacle during the insertion of fluid into the expandable member to expand the expandable member from the first configuration to the second configuration.

19. The mould system of claim 16, wherein the mould system is a paper pulp receptacle mould system.

20. A non-transitory storage medium storing machine-readable instructions that, when executed by a processor of a mould system comprising a mould and an expandable member, in a first configuration, located within a partially formed receptacle, cause the processor to:
cause the expandable member to move into contact with a base of the partially formed receptacle such that the expandable member deforms toward a periphery of the base of the partially formed receptacle; and
cause fluid to be inserted into the expandable member to expand the expandable member from the first configuration to a second configuration more expanded than the first configuration so as to urge the partially formed receptacle against an inner surface of the mould during a process to form the receptacle from the partially formed receptacle.
